(19) United States
(12) Patent Application Publication
(10) Pub. No.: US 2024/0174869 A1
(43) Pub. Date: May 30, 2024

(54) Fouling Control Coating Composition

(71) Applicant: Akzo Nobel Coatings International B.V., Amsterdam (NL)

(72) Inventors: Joanne GRANT, Amsterdam (NL); Elodie Odette Gisele MCGEE, Amsterdam (NL); Kathryn M. RILEY, Amsterdam (NL); Maria CONWAY, Amsterdam (NL); Ana Julie SANSÉAU-BLANCHARD, Amsterdam (NL)

(21) Appl. No.: 18/283,986

(22) PCT Filed: Mar. 30, 2022
(86) PCT No.: PCT/EP2022/058360

§ 371 Date: Sep. 25, 2023

(30) Foreign Application Priority Data
Mar. 30, 2021 (EP) 21166072.5

(51) Int. Cl. C09D 5/16; C09D 183/06

(52) U.S. Cl. CPC C09D 5/1675; C09D 183/06

(57) ABSTRACT

The invention is directed to a fouling control coating composition comprising a functional polysiloxane, a functionalised acrylate-based polymer and a non-curable oligomeric or polymeric fluid, in which the functional polysiloxane and functionalised acrylate-based polymer comprise a siyl moiety of the formula —Si(OR^{a})ₐ(R^{b})₃₋ₐ, where a is from 1 to 3, R^{a} is selected from H or optionally substituted C₁₋₁₂ alkyl, phenyl, and phenyl comprising one or more C₁₋₆ alkyl groups, and R^{b} is selected from H and also from optionally substituted C₁₋₂₀ aliphatic hydrocarbyl, C₈₋₁₂ aryl, and C₆₋₁₂ aryl comprising one or more C₁₋₆ aliphatic hydrocarbyl groups.

### TECHNICAL FIELD

This invention relates to a fouling control coating composition, to a substrate or article coated with such a fouling control coating composition, and to a method for controlling aquatic biofouling on man-made objects using such a coating.

### BACKGROUND ART

Fouling of ship hulls and other water-borne objects by aquatic organisms is a continuing problem. Fouling can increase frictional resistance of boats in the water, increasing fuel costs. On static structures, for example on drilling rigs, it can alter the water flow around the supporting legs, risking unpredictable and increased stresses. Fouling can also make inspections more difficult by obscuring defects and cracks. It can further reduce the cross-sectional area of pipework such as cooling water or ballast tank intakes, leading to reduced flow rates.

Coatings can be used to reduce fouling. Such coatings can contain a biocide to control the growth of aquatic organisms on the surface. These fall typically into two broad categories, namely “hard” antifouling coatings, where biocide gradually leaches from the coating over time, and “eroding” antifouling coatings (sometimes called self-polishing coatings), where the coating gradually erodes to release the biocide. However, biocides can carry environmental risks, particularly in areas with heavy shipping activity. They are therefore the subject of increasingly stringent environmental legislation.

Biocide-free coatings are available, often termed “fouling control” or “fouling release” coatings, which result in a “low surface energy” surface that not only inhibits adherence of fouling organisms, but also causes them to be more easily washed from the surface.

Examples of biocide-free coatings include those described in GB1307001 and U.S. Pat. No. 3,702,778, in which the coatings are based on silicone rubber. WO93/13179 describes protective coatings comprising curable organohydrogen polysiloxane or polydiorganosiloxane and a polymer comprising functional groups, wherein the majority of repeat units of the polymer are not siloxane units. WO2012/146023 describes a low surface energy coating composition comprising a silane-terminated polyurethane and a silane-terminated polysiloxane. WO2013/107827 describes a foul release composition comprising a curable polysiloxane and a silane-terminated polyurethane. WO2014/131695 describes a coating composition comprising a curable organosiloxane polymer and a fluorinated oxyalkylene-containing polymer or oligomer. WO99/33927 describes a process for inhibiting fouling on a substrate by applying a coating layer comprising a curable polysiloxane or fluorine-containing polymer to a coating comprising a film-forming polymer having curable silicon-containing functional groups. EP1518905 describes antifouling compositions comprising a diorganopolysiloxane with Si-bonded hydroxyl or hydrolysable groups, a silane with at least two hydrolysable groups per molecule, and a diorganopolysiloxane with non-reactive hydrocarbon groups bonded to Si. EP2143766 describes an antifouling coating composition comprising a curable organic resin, a silicone oil having a polyether, a long-chain alkyl and an arylalkyl group. U.S. Pat. No. 6,187,447 describes condensation curable coating compositions that can be used as foul-release coatings, comprising a vulcanizable polyorganosiloxane composition and a silanol-free polyorganosiloxane. U.S. Pat. No. 8,921,503 describes a process for physically deterring fouling from a substrate in an aquatic environment, by applying a coating comprising a curable polysiloxane polyalkylene oxide block copolymer. U.S. Pat. No. 9,822,220 describes an antifouling coating system comprising a base coating and an antifouling coating composition comprising a hydroxyl-terminated polydimethylsiloxane, and a curable polyether-containing silane. WO2020/011839 relates to a tie-coat composition that can be used with foul release coating compositions comprising resins with condensable silane groups.

A disadvantage of polysiloxane-based compositions is that many other coatings do not adhere to them. This becomes a problem if, through accidental spillage or inadequate masking, a polysiloxane coating is applied to or contaminates a surface when there is still a need to apply other coating layers. If the surfaces are not cleaned or otherwise treated to remove the contamination, negative effects such as blistering, pin holes and fish eyes can appear in the subsequently applied coating. This can also happen if coating equipment is not fully cleaned before being used for other coating compositions. The equipment must either be fully cleaned beforehand, or separate dedicated equipment must be used.

WO2019/115020 and WO2019/15021 have previously addressed this problem. They describe non-aqueous foul release coating compositions or layers that are essentially free of curable polysiloxane, and which employ polyurethane, polyether, polyester or polycarbonate resins modified with an alkoxysilyl group. However, there remains a need for further biocide-free fouling release compositions that can adhere to subsequently applied coating compositions.

### SUMMARY OF INVENTION

The present invention is a fouling control coating composition comprising a functional polysiloxane, a functionalised acrylate-based polymer, and a non-curable polymeric or oligomeric fluid. The coating can optionally additionally comprise a cross-linking agent and/or a cross-linking catalyst. The functional polysiloxane and the functionalised acrylate-based polymer each comprise a silane moiety of formula —Si(R^{b})₃₋ₐ(OR^{a})ₐ.

Each R^{a} is independently selected from H, C₁₋₁₂ alkyl, phenyl and phenyl substituted with 1 or more (e.g. 1 to 4) C₁₋₆ alkyl groups.

Each R^{b} is independently selected from H and R^{c}

Each R^{c} is independently selected from optionally substituted C₁₋₂₀ aliphatic hydrocarbyl groups, optionally substituted C₆₋₁₂ aryl groups, and optionally substituted C₆₋₁₂ aryl groups having one or more C₁₋₆ alkyl groups.

a is an integer in the range of from 1 to 3.

R^{a}, R^{b} and R^{c} can each optionally comprise one or more substituents or additional substituents as described in the section “Optional Substituents”.

The present invention is also directed to a method for controlling aquatic biofouling on a man-made object, comprising applying the above coating composition onto the surface of a man-made structure.

The invention is further directed to a substrate or article coated with the above-mentioned fouling control coating composition, both before and after drying and/or curing.

The invention is additionally directed to the use of such a coating composition for controlling aquatic biofouling of a man-made structure.

It has been found that the above compositions not only have improved adhesion characteristics to other coating layers, but also high fouling control activity, in particular long-term fouling control activity. In addition, the coating compositions have improved coating hardness (correlated with improved abrasion and damage resistance). Further, because they can adhere directly to substrates or primer coats, they can be used without the need for a tie-coat, thus helping reduce the complexity of the application scheme.

### DESCRIPTION OF EMBODIMENTS

In the discussion below, reference to quantities of components in the coating composition as a whole are to the uncured or undried composition, unless otherwise stated. Also, unless otherwise stated, concentrations given are in wt % of the total coating composition. Where a coating composition is provided in separate parts (e.g. a binder-containing part and a cross-linking agent-containing part) the amount of a component in the total coating composition is based on the total amount after combining the different parts, e.g. immediately after mixing.

References to “terminal” groups in a resin, polymer or oligomer are to groups bound to the oligomer/polymer chain or “backbone” at the end (terminal) positions. References to “pendant” groups are to groups attached to the oligomer/polymer chain at positions other than terminal positions.

References to “aliphatic hydrocarbyl” groups or substituents include saturated and unsaturated hydrocarbyl groups (e.g. alkyl or alkenyl groups), which can be cyclic, linear or branched, or comprise a mixture of cyclic and non-cyclic portions. Similarly, references to “alkyl” or “alkenyl” groups or substituents includes cyclic, linear or branched groups, or groups comprising a mixture of cyclic and non-cyclic portions.

The monomer (or monomer unit) content of a polymer or oligomer, expressed in either weight % or molar %, can be calculated from, respectively, the weight fraction or the mole fraction of monomer used to make the polymer or oligomer.

The term “monomer unit” refers to a constituent monomer of a polymer, i.e. to the moiety derived from the monomer after being incorporated into a polymer.

[Silane Moiety]

The functional polysiloxane and the functionalised acrylate-based polymer each comprise a silane moiety of general formula —Si(R^{b})₃₋ₐ(OR^{a})ₐ, as defined above.

In any of these silane moieties, R^{b} can be an R^{c} group, also as defined above. In further embodiments, any R^{c} group can be selected from (optionally substituted) C₁₋₆ aliphatic hydrocarbyl, phenyl and phenyl having one or more C₁₋₆ aliphatic hydrocarbyl groups. In further embodiments, R^{c} can be selected from (optionally substituted) C₁₋₆ alkyl, phenyl and phenyl substituted with one or more C₁₋₆ alkyl substituents.

In any of these silane moieties, any R^{a} group can be selected from H and C₁₋₆ alkyl. In further embodiments, all R^{a} groups in a silane moiety can be the same as each other.

In embodiments, there are no halides or halide-containing groups on the silane moiety.

[Functional Polysiloxane]

The composition comprises one or more functional polysiloxanes, which are curable and which have one or more silane moieties as defined above. These moieties can be at pendant or terminal positions of the functional polysiloxane, or at both pendant and terminal positions. Such moieties can react with each other to form larger polysiloxane molecules, or can react with moieties on other components, e.g. on the acrylate-based polymer, upon application of the coating composition to a substrate.

The polysiloxane can also comprise other substituents, as described below in the section “Optional Substituents”.

Preferably, there are at least two silane moieties in the functional polysiloxane. The polysiloxane can be linear, branched or cyclic, or can comprise a mixture of cyclic and non-cyclic portions or regions. In embodiments, the functional polysiloxane can be represented by Formula (1):

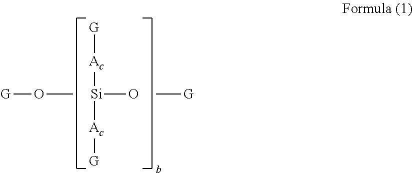

Each A is [O—Si(R^{c})₂—O].

Each G is selected from R^{b} and —Si(R^{b})₃₋ₐ(OR^{a})ₐ. In embodiments, any or all R^{b} groups can be R^{c}. In embodiments, any or all G-A_{c}-Si-A_{c}-G units are R^{b}-A_{c}-Si-A_{c}-R^{b} units. In further embodiments, any or all R^{b} in R^{b}-A_{c}-Si-A_{c}-R^{b} are R^{c}.

b is in the range of from 4 to 100.

Each c independently is in the range of from 0 to 5, for example from 0 to 3.

In embodiments, the functional polysiloxane can be represented by Formula (2):

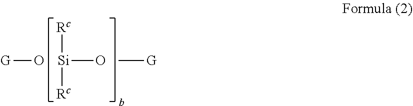

In such molecules, the terminal positions comprise silane moieties.

In embodiments, each G can be R^{b} or R^{c}. In further embodiments, the R^{c} groups can be selected from (optionally substituted) aliphatic hydrocarbyl and phenyl.

In further embodiments, the functionalised polysiloxane is represented by Formula (3):

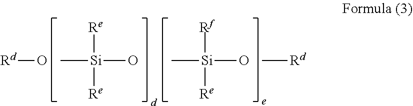

In Formula (3), the repeat units (whose relative molar ratios are represented by d and e) can be arranged in a random, alternating or block configuration.

Each R^{d} is independently selected from H and R^{e}.

Each R^{e} is independently selected from C₁₋₆ alkyl, phenyl and phenyl substituted with one or more C₁₋₆ alkyl substituents. Each alkyl group, alkyl substituent and phenyl group can be optionally substituted as set out in the section “Optional Substituents”.

Each R^{f} is independently selected from C₆₋₁₀ aryl, C₆₋₂₀ aliphatic hydrocarbyl and C₆₋₁₀ aryl substituted with one or more (for example from 1 to 4) C₁₋₆ aliphatic hydrocarbyl groups. Any aliphatic hydrocarbyl group and substituent, and any aryl group can optionally be substituted as set out below in the section “Optional Substituents”.

d is in the range of from 1 to 100.

e is in the range of from 0 to 99.

The sum of d+e is in the range of from 4 to 100. In embodiments, the ratio of e/d is no more than 1, for example in the range of from 0.01 to 1.00, such as from 0.05 to 0.50, or from 0.08 to 0.30.

R^{f} is different from all R^{d} and R^{e} groups. In embodiments, in Formula (3), all occurrences of R^{d} and R^{e} have fewer carbon atoms than R^{f}. In embodiments, all occurrences of R^{d} and R^{e} are the same. In embodiments, R^{d} and R^{e} are optionally substituted C₁₋₂ alkyl and R^{f} is selected from optionally substituted C₄₋₁₀ alkyl and optionally substituted phenyl.

In embodiments, in any or all of Formulae (1), (2) and (3), b or the sum of d+e can be in the range of from 10 to 80. For the functionalised polysiloxane as a whole, the average value for b (or for d+e) is in the range of from 4 to 100, for example from 10 to 80.

In embodiments, in any or all of Formulae (1), (2) and/or (3), there are no halides or halide-containing substituents.

In embodiments, the optionally substituted C₆₋₁₂ aryl group in R^{f} is an optionally substituted phenyl group.

The weight average molecular weight (Mw) of the functional polysiloxane can be in the range of from 500 to 10000, for example from 700 to 5000, or from 800 to 3000.

In embodiments, the functional polysiloxane has a viscosity (at 25° C.) in the range of from to 500 cP, for example from 50 to 400 cP, such as from 70 to 250 cP.

The content of functional polysiloxane in the coating composition, in embodiments, is in the range of from 3 to 50 wt %, for example from 5 to 35 wt %.

[Functionalised Acrylate-Based Polymer]

The coating composition comprises one or more functionalised acrylate-based polymers, which comprise a silane moiety as defined above in the section “Silane Moiety”. This moiety can react with the corresponding moiety on the functional polysiloxane upon application of the coating composition to the substrate. In embodiments, there are two or more such silane moieties per functionalised acrylate-based polymer molecule.

In embodiments, the functionalised acrylate-based polymer can comprise one or more further optional substituents, as defined below in the section “Optional Substituents”.

The silane moiety and any other optional substituents can be anywhere on the functionalised acrylate-based polymer, for example being on an acrylate-based monomer unit, or on a non-acrylate-based co-monomer unit. In embodiments, the silane moiety, or at least one silane moiety, is on an acrylate-based monomer unit.

By “acrylate-based” polymer is meant a polymer comprising one or more acrylate-based monomer units, i.e. derived from monomers having an acrylate moiety, in which a C═C double bond is directly bonded to a carbonyl (C═O) group, as found for example in acrylic acids, acrylic esters and acrylamides.

In embodiments, the functionalised acrylate-based polymer is derived from one or more monomers represented by Formula (4):

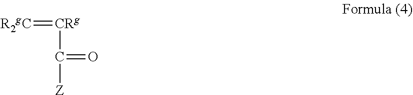

Z is selected from —OR^{h} and —NR^{h}₂. In embodiments, group Z is selected from OR^{h}.

Each R⁹ is independently selected from H and C₁₋₂₀ aliphatic hydrocarbyl (e.g. alkyl), C₆₋₁₂ aryl and C₆₋₁₂ aryl substituted with one or more (e.g. 1 to 4) C₁₋₆ aliphatic hydrocarbyl groups. Each aliphatic hydrocarbyl substituent, aliphatic hydrocarbyl group and aryl group can optionally be substituted as described further under the section “Optional Substituents”.

In embodiments, the C₁₋₂₀ aliphatic hydrocarbyl can be selected from C₁₋₁₀ or C₁₋₆ aliphatic hydrocarbyl groups, such as C₁₋₁₀ or C₁₋₆ alkyl groups. In embodiments, each R⁹ is selected from hydrogen and methyl.

Each R^{h} is independently selected from H and C₁₋₂₀ alkyl, optionally substituted as set out further in the section “optional substituents”. In embodiments, the C₁₋₂₀ alkyl is C₁₋₁₀ or C₁₋₆ alkyl.

At least one monomer unit in the functionalised acrylate-based polymer comprises the silane moiety. Where the functionalised acrylate-based polymer is a co-polymer, then one or more of the monomer units can have the silane moiety. In embodiments, the silane moiety is a substituent on group R^{g} or R^{h}, and in further embodiments it is a substituent on R^{h}. In the silane moiety, each R^{b} can be R^{c}. In further embodiments each R^{a} and R^{c} are selected from C₁₋₄ alkyl, and a is 2 or 3.

In embodiments, the monomer(s) from which the functionalised acrylate-based polymer is derived is (are) selected from acrylic acid, methacrylic acid, acrylic acid, itaconic acid, maleic acid, crotonic acid, and their esters and amides, for example those where Z is selected from —OR^{h} and —NR^{h}₂ as defined above. In embodiments the R^{h} group is selected from H and optionally substituted C₁₋₆ alkyl. In further embodiments, at least one of the monomers from which the polymer is derived is selected from esters of the acids listed above in which R^{h} is selected from C₁₋₆ alkyl substituted with a silane moiety, i.e. an —Si(R^{b})₃₋ₐ(OR^{a})ₐ group (e.g. an —Si(R^{c})₃₋ₐ(OR^{a})ₐ group).

In embodiments, at least one monomer is selected from esters and substituted amides of acrylic acid, methacrylic acid, acrylamide and methacrylamide, where at least one R^{h} is not H. In embodiments, the functionalised acrylate-based polymer is based on one or more monomers selected from esters of acrylic acid and esters of methacrylic acid. In embodiments, these can be selected from methyl methacrylate, butyl acrylate and lauryl methacrylate.

The functionalised acrylate-based polymer can be a copolymer solely of monomers of Formula (4). In other embodiments, the functionalised acrylate-based polymer can be a copolymer formed from one or more acrylate-based monomers, e.g. of Formula (4), and one or more other monomers.

Typically, acrylate-based monomer units constitute 10% or more of the functionalised acrylate-based polymer on a molar basis, for example 20% or more. In further embodiments, acrylate-based monomers constitute 20 wt % or more, for example 30 wt % or more, based on the total amount of monomers used to form the functionalised acrylate-based polymer.

Other types of co-monomer (i.e. non acrylate-based monomers) include those having polymerizable unsaturated carbon-carbon bonds, which can participate in the chain-propagation reaction with the functionalised acrylate-based monomers described above.

Such other types of co-monomer are, in embodiments, represented by Formula (5):

CR₂^{j}=CR^{j}R^{k} Formula (5)

Each R^{j} is independently selected from H, halide (e.g. selected from F and Cl), and C₁₋₆ alkyl. R^{k} can be selected from R^{j}, a silane moiety (as defined above under “Silane Moiety”), C₂₋₆ alkenyl, C₆₋₁₂ aryl and C₆₋₁₂ aryl substituted with one or more C₁₋₆ aliphatic hydrocarbyl groups. In embodiments, only one of R^{j} and R^{k} can be a halide or comprise a halide-containing substituent. In embodiments, the co-monomer can comprise one or more optional substituents, as set out below in the section “Optional Substituents”, for example being substituents on alkyl, alkenyl or aryl groups in R^{j} or R^{k}.

The co-monomer can comprise a silane moiety, for example as a substituent on a R^{j} or R^{k} group, or being an option for the R^{k} group.

Styrene monomers fall within the scope of Formula (5), for example where R^{k} is an optionally substituted phenyl or alkyl-phenyl group. In embodiments, for styrene monomers, R^{J} is selected from H, halide and C₁₋₆ alkyl, and R^{k} is selected from phenyl or phenyl with one or more C₁₋₆ alkyl groups, where each R^{j} and R^{k} is optionally substituted with halide, OR^{t} and NR^{t}₂, where R^{t} is selected from H, C₁₋₆ alkyl and C₁₋₆ haloalkyl. In further embodiments of styrene monomers, R^{j} is selected from H and methyl, and R^{k} is phenyl or C₁₋₄ alkyl-substituted phenyl.

In embodiments, the monomer of Formula (5) is selected from vinyl chloride, ethylene, propylene, butadiene and styrene, any of which can optionally be substituted.

The average number of monomer units in the functionalised acrylate-based polymer can be in the range of from 5 to 500, for example from 10 to 200.

Where the functionalised acrylate-based polymer comprises an aryl group as R^{k}, for example in styrene-based co-monomer units, the amount of styrene-based co-monomer units in the functionalised acrylate-based polymer can be up to 80% on a molar basis, for example in the range of from 10 to 80% (based on the total amount of monomer used to make the polymer). In other embodiments, where R^{k} does not comprise an aryl group, the content of acrylate-based monomer is in the range of from 80% or more on a molar basis, for example 90% or more, 95% or more, or 99% or more.

In embodiments, the total content of functionalised acrylate-based polymer(s) in the coating composition is in the range of from 5 to 70 wt %, for example from 7 to 60 wt %, or from 10 to 55 wt %, based on the entire coating composition.

Where the functionalised acrylate-based polymer is a copolymer, the monomer units can be distributed in a random, alternating or block configuration.

In embodiments, the silane-functionalised acrylate-based polymer is a copolymer comprising monomer units selected from each of Formulae (6) and (7):

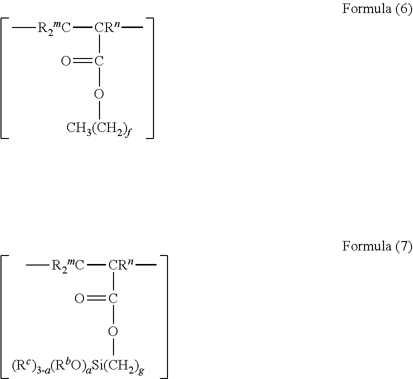

f is in the range of from 0 to 20, and g is in the range of from 1 to 6. In embodiments, the functionalised acrylate-based polymer comprises two or more monomer units of Formula (6), each having different values for f.

Each R^{m} and each Rⁿ is selected from H and C₁₋₄ alkyl, for example H and C₁₋₂ alkyl. In embodiments, each R^{m} is H, and each Rⁿ is H or methyl.

Monomer units of Formula (6) can represent 20 mol % or more of the total amount of monomer units in the functionalised acrylate-based polymer. Acrylate monomers according to Formula (6) can make up 30 wt % or more of the functionalised acrylate-based polymer, based on the total amount of monomer used to make the polymer.

The weight average molecular weight (Mw) of the functionalised acrylate-based polymer (or co-polymer) is, in embodiments, in the range of from 500 to 10000, for example in the range of from 1000 to 6000, such as from 2000 to 4500.

[Cross-Linking Agents]

The composition optionally comprises one or more cross-linking agents that can facilitate cross-linking of the acrylate-based polymer and the functional polysiloxane. Typically, they comprise at least two moieties that can form cross-links with the functional polysiloxane and/or the functionalised acrylate-based polymer during the drying and curing process.

The cross-linking agent, in embodiments, can be selected from those of formula Si(R^{c})₄₋ₕ(OR^{a})ₕ, where h is an integer in the range of from 1 to 4. R^{a} and R^{c} are as defined above for the “Silane Moiety”. When h is less than 4, at least one R^{c} comprises either an unsaturated aliphatic hydrocarbyl group or comprises a substituent as set out in the section “Optional Substituents”. In embodiments, the silane moiety comprises no halides or halide-containing substituents.

There can be more than one cross-linking agent present, although preferably at least one cross-linking agent has a value for h of at least 2.

In embodiments, the aliphatic hydrocarbyl groups and/or substituents in R^{c} are saturated (i.e. are alkyl) and at least one R^{c} comprises one or more of the additional substituents set out in the section “Optional Substituents”.

In embodiments, cross-linking agents of formula Si(R^{c})₄₋ₕ(OR^{a})ₕ can be in a partially hydrolysed or condensed form, for example being in dimeric or oligomeric form where two or more silicon atoms are bound via Si—O—Si bonds. In embodiments, partially hydrolysed or condensed forms comprise from 2 to 20 silicon atoms.

In embodiments, at least one R^{c} group is selected from C₁₋₆ alkyl, phenyl and C₁₋₆ alkyl-substituted phenyl, in which there are one or more of the additional substituents referred to above.

In embodiments, all R^{a} groups are selected from H and C₁₋₄ alkyl. In other embodiments, each R^{c} group is selected from H, and substituted C₁₋₄ alkyl. In further embodiments, the cross-linking agent can be of formula Si(OR^{a})₄, and each R^{a} is selected from H and C₁₋₄ alkyl.

In embodiments the cross-linking agent comprises an R^{c} group selected from C₁₋₄ alkyl substituted with an amine-containing substituent or or an epoxy-containing substituent. In embodiments, at least one R^{c} comprises an epoxy-containing substituent. Where h is less than 3, other R^{c} groups are selected from unsubstituted C₁₋₂₀ aliphatic hydrocarbyl groups, e.g. C₁₋₆ alkyl groups.

When R^{c} contains an amine substituent, it can be of formula —(CR^{m}₂)ⱼ[NR^{m}(CR^{m}₂)ₖ]ₘNR^{m}₂ where j is from 1 to 6, such as from 2 to 4, k is from 2 to 3, and m is from 0 to 3, for example from 0 to 2. In embodiments, all R^{m} are selected from H and C₁₋₂ alkyl, and in further embodiments only one R^{m} group is other than H.

When R^{c} contains an epoxy-group, it can be of formula —(CR^{m}₂)ⱼ[O(CR^{m}₂)ₖ]ₙ[CR^{m}(O)CR^{m}₂]. In embodiments, all R^{m} are selected from H and C₁₋₂ alkyl, and in further embodiments only one R^{m} group is other than H. j is from 1 to 6, for example from 2 to 4, k is from 2 to 3, and n is from 1 to 3, for example from 1 to 2.

Examples of cross-linking agents include 3-aminopropyl triethoxysilane, N-[3-(trimethoxysilyl)propyl]ethylenediamine, (N,N-diethylaminomethyl)triethoxysilane, glycidyloxypropyl triethoxysilane, glycidyloxypropyl trimethoxysilane and tetraethoxysilane (TEOS), and partially hydrolysed forms thereof.

In embodiments, the cross-linking agent is a condensate of an alkyl silicate, for example a C₁₋₆ alkyl silicate, such as a partially hydrolysed tetraethyl orthosilicate (TEOS). Such condensates can be dimeric or oligomeric, for example comprising from 2 to 20 silicon atoms linked via Si—O—Si bonds.

In embodiments, the total content of the cross-linking agent(s) in the coating composition is in the range of from 0.1 to 30 wt %, based on the entire coating composition, for example in the range of from 0.5 to 25 wt %, or 1 to 20 wt %.

[Non-Curable Polymeric or Oligomeric Fluid]

The composition comprises a non-curable polymeric or oligomeric fluid. It is typically a non-volatile substance, that is liquid phase at standard temperature and pressure (25° C. and atmospheric pressure, i.e. 1.013 bar), and which does not evaporate after application of the coating to a substrate, thus remaining in the coating after the drying and curing process. It is therefore formally classed as a constituent of the “non-volatile” or “solids” portion of the coating composition. It does not undergo cross-linking reactions with other components of the composition during the curing process, and hence is essentially a non-reactive component of the composition.

The non-curable polymeric or oligomeric fluid is formed from polymerisation or oligomerisation of one or more monomers. They are distinct from fluids which may comprise large molecules, but which are not derived from a polymerisation or oligomerisation reaction, for example hydrocarbon fluids extracted from or originating from crude oil fractions.

The non-curable polymeric or oligomeric fluid is a non-volatile fluid, which in embodiments has a melting point of less than 0° C., for example less than −10° C. or less than −20° C., and a boiling point greater than 150° C., for example greater than 175° C. or greater than 190° C., at atmospheric pressure (i.e. 1.013 bar).

In embodiments, the non-curable oligomeric or polymeric fluid is a non-curable (often termed non-functional) polysiloxane fluid. In embodiments, the non-functional polysiloxane has a weight average molecular weight (M_{w}) in the range of from 500 to 8000. In embodiments, the molecular weight (M_{w}) is from 1000 to 7000, or from 2000 to 6000. In embodiments, the viscosity (at 25° C.) is in the range of from 10 to 40000 cP, for example in the range of from to 10000, such as from 30 to 1000 cP.

The non-curable oligomeric or polymeric fluid is substantially unreactive with the polymeric matrix that results from cross-linking of the curable or reactive components, and can help enhance the antifouling activity, and avoid the need for a biocidal component.

In embodiments, the non-curable oligomeric or polymeric fluid is a non-functional polysiloxane fluid represented by Formula (8):

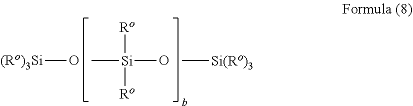

Each R^{o} is independently selected from C₁₋₂₀ alkyl groups, C₆₋₁₂ aryl groups and C₆₋₁₂ aryl groups substituted with one or more (for example from 1 to 4) C₁₋₆ alkyl groups. Each alkyl group, alkyl substituent and aryl group can optionally be substituted as set out in the section “Optional Substituents”.

In embodiments, the optional substituents can be selected from halide and OR^{p}.

Each R^{p} is independently selected from C₁₋₁₂ alkyl, which in turn is optionally substituted with one or more groups selected from halide, C₁₋₆ alkoxy, C₁₋₆ haloalkoxy, —([CR^{m}₂]ₖO—)ₚR^{m} and —([CR^{m}₂]ₖO—)ₚC(O)R^{m}. p is from 1 to 20.

Each R^{m} can, in embodiments, be selected from H and C₁₋₂ alkyl.

In embodiments, b is in the range of from 4 to 100, for example from 10 to 80.

In embodiments, the non-functional polysiloxane comprises a polyether group and also alkyl groups. Examples include those represented by Formula (9):

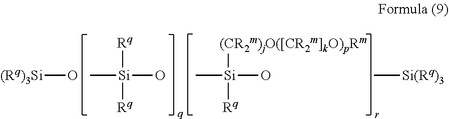

In Formula (9), the repeat units (whose relative molar ratios are represented by q and r) can be arranged in a random, alternating or block configuration. The ratio of q:r is in the range 0.1:1 to 100:1, for example from 1:1 to 70:1. In further embodiments, the ratio is in the range of from 2:1 to 35:1.

Each R^{q} is independently selected from C₁₋₂₀ alkyl, phenyl and phenyl substituted with one or more C₁₋₆ alkyl substituents, which can be optionally substituted as set out in the section “Optional Substituents”.

Further examples of non-functional polysiloxanes can be represented by Formula (10):

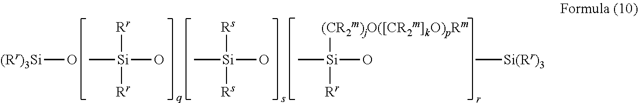

In Formula (10), the repeat units (whose relative molar ratios are represented by q, r and s) can be arranged in a random, alternating or block configuration.

Each R^{r} is selected from C₁₋₄ alkyl, for example C₁₋₂ alkyl or methyl. Each R^{s} is selected from C₆₋₁₀ aryl, C₅₋₂₀ alkyl and C₆₋₁₀ aryl optionally substituted with one or more C₁₋₆ alkyl groups. Any alkyl group, alkyl substituent or aryl group in R^{r} and R^{s} can optionally be substituted with one or more groups selected from halogen (e.g. F or CI), hydroxy, C₁₋₆ alkoxy and C₁₋₆ haloalkoxy (e.g. where each halide is selected from F and Cl). q, r and s represent molar amounts of the respective siloxane units. In embodiments, the molar ratio q:r:s is in the range: 10.0:0.0-8.0:0.0-8.0, where at least one of r or s is greater than zero, for example at least 0.5.

In embodiments, one of r and s is zero. In embodiments, the molar ratio range for q:r:s is selected from 10.0:0.0:1.0-5.0, and from 10:0.3-2.0:0.0. Where r is zero, R^{s} can be selected from C₆₋₁₀ aryl, such as phenyl.

In other embodiments, both r and s are greater than zero, for example q:r:s is in the range of from 10.0:0.5-4.0:1.0-6.0. In such embodiments, R^{s} can be selected from optionally substituted C₅₋₂₀ alkyl.

In embodiments, all occurrences of R^{r} are methyl, s is zero, the molar ratio range q:r is 10.0:0.5-2.0, group (CR^{m}₂)ⱼO([CR^{m}₂)ₖO)ₚR^{m} is selected from —(CH₂)ⱼO(CH₂CH₂O)ₚC(O)Me, —(CH₂)ⱼO(CH₂CH₂O)ₚC(O)Et and —(CH₂)ⱼO(CH₂CH₂O)ₚH, where j is in the range of from 2 to 4, and p is in the range of from 6 to 14.

In embodiments, all occurrences of R^{r} are methyl, r is zero, the molar ratio range q:s is 10.0:1.0-6.0, and R^{s} is Ph or C₈₋₁₄ alkyl.

In embodiments, all occurrences of R^{r} are methyl, the molar ratio range for q:r:s is 10.0 0.5-4.0:1.0-6.0, R^{s} is selected from C₈₋₁₄ alkyl, and in (CR^{m}₂)ⱼO([CR^{m}₂]ₖO)ₚR^{m} is (CH₂)ⱼO([CH₂CH₂O)ₚH, where j is in the range of from 2 to 4, and p is in the range of from 6 to 14.

Where there are different types of monomeric units in the polysiloxane fluid, they can be distributed in the polymer or oligomer chain in a random, alternating or block configuration. Thus, in Formulae (9) and (10), the different monomers do not necessarily appear in the same positional order as shown above, the Formulae being merely a convenient way of expressing the different types of monomer units present, and their relative amounts.

Examples of non-functional polysiloxane fluids include hydrophilic-modified polysiloxane oils such as methylphenyl polysiloxanes and poly(oxyalkylene)-modified polysiloxanes. Examples include Dow Corning products DC5103, DC Q2-5097, DC193, DC Q4-3669, DC Q4-3667, DC57 and DC2-8692. Other examples include Silube™ J208 from Siltech and BYK333 from BYK.

Other non-curable fluids include polyethers, perfluoropolyethers, and halogenated hydrocarbon polymers such as fluorocarbons, hydrofluorocarbons, chlorofluorocarbons and hydrochlorofluorocarbons. Examples of such fluids include trifluoromethyl fluorine end-capped perfluoropolyethers, such as Fomblin™ Y, Krytox™ K, Demnum™ S, Fomblin™ Z DOL and Fluorolink™ E fluids.

Further examples include fluorinated alkylene and oxyalkylene-containing polymers or oligomers, such as those described in WO2014/131695. Also included are polychlorotrifluoroethylenes such as Daifloil™ CTFE fluids.

Further non-curable fluids that can be used include sterols and sterol derivatives such as sterol esters. Examples include lanolin and acetylated lanolin.

In embodiments, the total content of non-curable oligomeric or polymeric fluid(s) in the coating composition is in the range of from 2 to 40 wt %, based on the entire coating composition, for example in the range of from 3 to 30 wt % or from 3 to 20 wt %, such as from 4 to 15 wt %.

[Additional Components]

The coating composition may optionally also contain other components, for example one or more substance selected from other curable resins, reactive diluents, anti-corrosion additives, pigments, gloss additives, waxes, rosins, fillers and extenders, thixotropic agents, plasticizers, inorganic and organic dehydrators (stabilizers), UV stabilizers, catalysts, antifouling agents, marine biocides, defoamers, non-volatile and non-reactive fluids, chain transfer agents and any combination thereof.

The total amount of such further optional components can be in the range of from 0 to 65 wt % based on the total content of the coating composition.

These components are well-known to the skilled person, although in some cases some examples are provided below.

[Additional Curable Resins]

The coating composition can optionally comprise one or more additional curable resins, although in minor amounts (on a weight basis) compared to the functional polysiloxane resin and/or the functionalised acrylate-based resin. In embodiments, the total amount of other curable resins in the coating composition as a whole is 20 wt % or less.

The resin can be based on an oligomer or polymer backbone of any type, but which is functionalised to enable it to react with other curable components of the coating composition. In embodiments, such polymers or resins can be saturated or unsaturated, and can be selected from polyether resins, polyester resins, alkyd resins, epoxy resins, polyamide resins, amino resins, phenolic resins, ketone and aldehyde resins, polycarbonate resins, polyisocyanate resins, polyurethane resins, polyolefins, polyhalocarbons, alkyd resins and rubber-based resins.

They also include hybrid systems based on any two or more of these different polymer/oligomer types, for example hybrids of carbon-based polymers and silicone-based polymers.

The additional curable resin comprises one or more functional groups that can react to form a cross-link with the functional siloxane and/or the functionalised acrylate-based polymer in the coating composition.

Functional groups for any additional curable resin can be selected from —OR^{m}, —NR^{m}₂, —NCO, —C(O)OR^{m}, —OC(O)R^{m}, —C(O)NR^{m}₂, —OC(O)NR^{m}₂, —NR^{m}C(O)NR^{m}₂, —OC(O)OR^{m} and —[CR^{m}(O)CR^{m}₂] groups. In embodiments, any or all of the R^{m} groups on these moieties can be selected from H and C₁₋₂ alkyl. In embodiments, there are no halides or halide-containing substituents on the functional groups.

Where the resin is not a functional polysiloxane or a functionalised acrylate-based resin as defined above, the optional additional curable resin can comprise a silane moiety, e.g. an —Si(OR^{a})ₐ(R^{b})₃₋ₐ group.

In embodiments, a hybrid silicone/polyepoxide polymer can be used. These can comprise, for example, a mixture of functional groups, such as silane moieties (e.g. trialkoxysilane groups where the alkoxy groups are C₁₋₆ alkoxy groups or C₁₋₄ alkoxy groups) and epoxide groups, for example —[CR^{m}(O)CR^{m}] groups such as —[CH₂(O)CH₂] groups. Examples of such hybrid resins include Silikopon™ materials ED, EF and EW from Evonik, SLM 43226 from Wacker, and ES-1002 and ES-1001T from ShinEtsu.

[Optional Substituents]

Optional substituents referred to above are as follows: Where halides are referred to, these can be selected from F and Cl.

For R^{a}, the optional substituents are selected from halide, —OR^{t} and —NR^{t}₂.

R^{t} is selected from H, C₁₋₆ alkyl and C₁₋₆ haloalkyl. In embodiments, R^{t} is selected from H and C₁₋₄ alkyl. In embodiments, the optional substituent on R^{b} is selected from —OH and —NH₂.

For R^{b}, R^{c}, R^{d}, R^{e}, R^{f}, R^{g}, R^{h}, R^{j} and R^{k}, the optional substituents are selected from halide, —OR^{t}, —NR^{t}₂, —NCO, —C(O)R^{t}, —C(O)OR^{t}, —OC(O)R^{t}, —C(O)NR^{t}₂, —OC(O)NR^{t}₂, —NR^{t}C(O)NR^{t}₂ and —OC(O)OR^{t}. Additional optional substituents include polyether, polyamine, polyether/amine and epoxy-containing groups selected from —([CR^{t}₂]ⱼE-)ₚR^{t}, -E-([CR^{t}₂]ⱼE-)ₚR^{t} and —(CR^{t}₂)ⱼ[O(CR^{t}₂)ₖ]ₘ[CR^{t}(O)CR^{t}₂], where [CR^{t}(O)CR^{t}₂] represents an epoxy moiety.

Each E is independently selected from O and NR^{t}. In embodiments, all E are O or all E are NR^{t}.

For R^{o}, R^{p} and R^{q} the optional substituents are selected from halide, —OR^{t}, —NR^{t}₂, —C(O)R^{t}, —([CR^{t}₂]ⱼE-)ₚR^{t}, -E-([CR^{t}₂]ⱼE-)ₚR^{t}.

For R^{r} and R^{s}, the optional substituents are selected from halogen, hydroxy, C₁₋₆ alkoxy and C₁₋₆ haloalkoxy.

In embodiments, an optionally substituted group can comprise from 1 to 4 substituents, for example 1 or 2 substituents.

In embodiments, where optional substituents are present, they can exist in so-called “reactive pairs”, such that (for example) the functional polysiloxane comprises one member of the reactive pair, and the acrylate-based polymer comprises the other member. In embodiments, they can be selected to form a link such as an ester link, an amide link, a urea link, or a carbamate link

In embodiments, the optional substituents on the functional polysiloxane or the acrylate-based polymer or both are selected from halide (e.g. selected from F and Cl), —OH, —C₁₋₆ alkoxy, —C₁₋₆ haloalkoxy, and —O—([CH₂CHR^{m}—O—)ₚR^{m}, where each R^{m} is selected from H and C₁₋₂ alkyl.

In embodiments, there are no halide or halide-containing substituents.

[Organic Solvents]

There can be one or more organic solvents. These are typically organic liquids that have a boiling point of 250° C. or lower at atmospheric pressure (i.e. 101.3 kPa). Once the coating composition is dried or cured, the organic solvent is no longer present in the composition.

When organic solvent is present, it can be selected from hydrocarbon compounds and heteroatom-containing organic compounds, where heteroatoms are selected from O, S and N, for example O.

Examples of organic solvents include alkyl aromatic hydrocarbons (such as xylene, toluene and trimethyl benzene), aliphatic hydrocarbons (such as cyclic and acyclic hydrocarbons selected from C₄₋₂₀ alkanes, or mixtures of any two or more thereof), alcohols (such as benzyl alcohol, octyl phenol, resorcinol, n-butanol, isobutanol and isopropanol), ethers (such as methoxypropanol), ketones (such as methyl ethyl ketone, methyl isobutyl ketone and methyl isopentyl ketone), and esters (such as butyl acetate). In embodiments, the organic solvent comprises from 2 to 20 carbon atoms, for example from 3 to 15 carbon atoms. Mixtures of any two or more organic solvents can be used.

When organic solvent is used, its amount in total can constitute up to 65 wt % of the total weight of the coating composition, for example up to 50 wt %, 30 wt %, 20 wt % or 10 wt % of the coating composition as a whole. In embodiments, it is in the range of from 1 to 65 wt % or from 1 to 50 wt %, for example from 5 to 45 wt %. In other embodiments, the organic solvent content is from 5 to 30 wt %.

The organic solvent content is separate to the water content. The coating composition is typically a non-aqueous composition. Although water can be present, it is typically at a low concentration. If present, it is typically at concentrations of 5 wt % or less, for example 1 wt % or less, such as 0.5 wt % or less, based on the coating composition as a whole.

[Marine Biocides]

The coating composition can, in embodiments, comprise one or more marine biocides. These are chemical substances known to have chemical or biological biocidal activity against marine or freshwater organisms.

Although the coating compositions described herein do not require any additional marine biocides to be effective, they can be incorporated if desired. In embodiments, where marine biocide is present, it is included at concentrations of 15 wt % or less, for example 10 wt % or less, such as 5 wt % or less. In embodiments, the marine biocide content is 1 wt % or less, such as 0.5 wt % or less based on the entire coating composition.

In embodiments, there is no added marine biocide in the composition.

If used, examples of suitable marine biocides are well-known in the art and include inorganic, organometallic, metal-organic or organic biocides.

Examples of inorganic biocides include copper compounds such as copper oxide, copper thiocyanate, copper bronze, copper carbonate, copper chloride, copper nickel alloys, and silver salts such as silver chloride or nitrate.

Organometallic and metal-organic biocides include zinc pyrithione (the zinc salt of 2-pyridinethiol-1-oxide), copper pyrithione, bis (N-cyclohexyl-diazenium dioxy) copper, zinc ethylene-bis(dithiocarbamate) (i.e. zineb), zinc dimethyl dithiocarbamate (ziram), and manganese ethylene-bis(dithiocarbamate) complexed with zinc salt (i.e. mancozeb).

Organic biocides include formaldehyde, dodecylguanidine monohydrochloride, thiabendazole, medetomidine, N-trihalomethyl thiophthalimides, trihalomethyl thiosulphamides, N-aryl maleimides such as N-(2,4,6-trichlorophenyl) maleimide, 3-(3,4-dichlorophenyl)-1,1-dimethylurea (diuron), 2,3,5,6-tetrachloro-4-(methylsulphonyl) pyridine, 2-methylthio-4-butylamino-6-cyclopopylamino-s-triazine, 3-benzo[b]thien-yl-5,6-dihydro-1,4,2-oxathiazine 4-oxide, 4,5-dichloro-2-(n-octyl)-3(2H)-isothiazolone, 2,4,5,6-tetrachloroisophthalonitrile, tolylfluanid, dichlofluanid, diiodomethyl-p-tosylsulphone, capsaicin and substituted capsaicins, N-cyclopropyl-N′-(1,1-dimethylethyl)-6-(methylthio)-1,3,5-triazine-2, 4-diamine, 3-iodo-2-propynylbutyl carbamate, medetomidine, 1,4-dithiaanthraquinone-2,3-dicarbonitrile (dithianon), boranes such as pyridine triphenylborane, 2-trihalogenomethyl-3-halogeno-4-cyano pyrrole derivatives substituted in position 5 and optionally in position 1, such as 2-(p-chlorophenyl)-3-cyano-4-bromo-5-trifluoromethyl pyrrole (tralopyril), furanones such as 3-butyl-5-(dibromomethylidene)-2(5H)-furanone, macrocyclic lactones such as avermectins, for example avermectin B1, ivermectin, doramectin, abamectin, amamectin and selamectin, and quaternary ammonium salts such as didecyldimethylammonium chloride and an alkyldimethylbenzylammonium chloride.

The biocide can, in embodiments, be wholly or partially encapsulated, adsorbed, entrapped, supported or bound. Certain biocides are difficult or hazardous to handle and are advantageously used in an encapsulated, entrapped, absorbed, supported, or bound form. Encapsulation, entrapment, absorption, support or binding of the biocide can provide a secondary mechanism for controlling biocide leaching from the coating system in order to achieve an even more gradual release and long-lasting effect. The method of encapsulation, entrapment, adsorption, support or binding of the biocide is not particularly limited. Examples include the use of mono and dual walled amino-formaldehyde or hydrolysed polyvinyl acetate-phenolic resin capsules or microcapsules as described in WO2006/032019. An example of a suitable encapsulated biocide is encapsulated 4,5-dichloro-2-(n-octyl)-3(2H)-isothiazolone marketed by Dow Microbial Control as Sea-Nine CR2 Marine Antifouling Agent. Examples of ways in which an absorbed or supported or bound biocide may be prepared include the use of host-guest complexes such as clathrates as described in EP0709358, phenolic resins as described in EP0880892, carbon-based adsorbents such as those described in EP1142477, or inorganic microporous carriers such as the amorphous silicas, amorphous aluminas, pseudoboehmites or zeolites described in WO00/11949.

[Reactive Diluent]

The coating composition can optionally comprise one or more reactive diluents. A reactive diluent behaves like a solvent in reducing the viscosity of a composition, but does not contribute to its solvent or VOC content because it possesses reactive groups which allow it either to bind to the coating resins, or to undergo a chemical reaction independent of the main curing reaction. They are typically of lower viscosity than the other binder components (e.g. the functionalised acrylate-based resin and functional polysiloxane resin), and do not generally form mechanically robust coatings in the absence of resin.

In embodiments, reactive diluents have a viscosity of 80 cP or less (at 25° C.), for example in the range of from 0.1 to 80. Binder resins (such as the functionalised acrylate-based polymer or any other optional additional curable resins) tend to have higher, viscosities for example 81 cP or more, such as in the range of from 81 to 50000 cP, from 200 to 30000, or from 1000 to 20000 cP.

In embodiments the reactive diluent can be selected from epoxy-containing resins which are aliphatic, or which comprise no more than one aromatic or heteroaromatic group. Specific examples of reactive diluents include phenyl glycidyl ether, C₁₋₃₀ alkyl phenyl glycidyl ethers (e.g. C₁₋₁₂ or C₁₋₅ alkyl phenyl glycidyl ethers such as methyl phenyl glycidyl ether, ethyl phenyl glycidyl ether, propyl phenyl glycidyl ether and para t-butyl phenyl glycidyl ether), and glycidyl esters of carboxylic acids (e.g. glycidyl esters of fatty acids or versatic acids such as pivalic acid or neodecanoic acid).

Further examples include alkyl glycidyl ethers, e.g. C₁₋₁₆ alkyl glycidyl ethers, e.g. where m is from 2 to 6. Examples include glycidyl ethers of di- and polyhydric aliphatic alcohols such as hexanediol diglycidyl ether, neopentyl glycol diglycidyl ether, trimethylolpropane triglycidyl ether, glycerol triglycidylether, pentaerythritol tetraglycidyl ether, dipentaerythritol polyglycidyl ethers, butanediol diglycidyl ether, neopentylglycol diglycidyl ether, and sorbitol glycidyl ether.

They can also be made by epoxidation of unsaturated fats and oils, for example unsaturated fatty acids, diglycerides or triglycerides having C₄₋₃₀ fatty acid or fatty acid ester groups. An example is Cardolite™ NC-513, which is made by reacting epichlorohydrin with an oil obtained from the shells of cashew nuts.

The reactive diluent can also be selected from epoxidized olefins, including dienes and polydienes. They can be C₂₋₃₀, C₆₋₂₈, C₆₋₁₈, C₁₄₋₁₆ or C₆₋₁₂ epoxidised olefins. They can comprise from 1 to 4 epoxy groups, for example 1 or 2 epoxy groups, such as 2 epoxy groups. Specific examples include diepoxyoxtane and epoxidized polybutadiene. Epoxidised polydienes such as polybutadiene can have a molecular weight in the range of from 500 to 100000, for example in the range of from 1000 to 50000, or from 2000 to 20000.

Still further examples of reactive diluents include dialkyl carbonates, e.g. C₁₋₁₆ dialkyl carbonates or C₁₋₆ dialkyl carbonates, such as dimethyl carbonate.

In embodiments, the reactive diluent is present in the first part (A) of a two-component coating composition, i.e. with the curable epoxy binder.

In the coating composition as a whole, the reactive diluent can be present in an amount of from 1.0 to 15.0 wt. %, for example from 2.0 to 12.0 wt %. These amounts can help lower the viscosity of the coating composition, which is advantageous for high solids and low solvent compositions.

In embodiments, the viscosity of the reactive diluent is less than 50 cP, for example less than 30 cP, or less than 20 cP at 23° C. and 50% RH. The viscosity can be measured using the cone and plate method described in ASTM D4287.

[Catalysts]

The coating composition can optionally comprise one or more catalysts suitable for catalysing condensation reactions, for example between silanol groups. Catalysts include carboxylic acid salts of various metals, for example tin, zinc, iron, lead, barium and zirconium. The carboxylate anion can, in embodiments, be derived from fatty acids, for example in dibutyl tin dilaurate, dioctyltin dilaurate, dibutyltin dioctoate, iron stearate, tin (II) octoate and lead octoate. Other examples include organobismuth compounds, organotitanium compounds, and organophosphates such as bis(2-ethylhexyl) hydrogen phosphate. Other possible catalysts include chelates, for example dubutyltin acetoacetonate, or compounds comprising amine ligands such as 1,8-diazabicyclo[5.4.0]undec-7-ene. The catalyst can further be selected from halogenated organic acids which have at least one halogen substituent on a carbon atom in an alpha and/or beta position to the carboxyl group, or a derivative which is hydrolysable to form such an acid under the conditions of the condensation reaction. Other catalysts are described in WO2007/122325, WO2008/055985, WO2009/106717 and WO2009/106718.

[Pigments, Fillers and Extenders]

In embodiments, one or more pigments can be included in the coating composition. They can be selected, for example, from extender pigments, colour pigments and barrier pigments.

Examples of suitable extender pigments (sometimes termed fillers) include barium sulphate, calcium sulphate, calcium carbonate, silicas or silicates (such as talc, feldspar, and china clay), including pyrogenic silica, bentonite and other clays. Some extender pigments, such as fumed silica, may have a thixotropic effect on the coating composition.

The proportion of extender pigments may be in the range of from 0 to 25 wt %, based on the total weight of the coating composition. Preferably clay is present in an amount of 0 to 1 wt % and preferably the thixotrope is present in an amount of 0 to 5 wt %, based on the total weight of the coating composition.

Examples of colour pigments include black iron oxide, red iron oxide, yellow iron oxide, titanium dioxide, zinc oxide, carbon black, graphite, red molybdate, yellow molybdate, zinc sulfide, antimony oxide, sodium aluminium sulfosilicates, quinacridones, phthalocyanine blue, phthalocyanine green, indanthrone blue, cobalt aluminium oxide, carbazoledioxazine, chromium oxide, isoindoline orange, bis-acetoaceto-tolidiole, benzimidazolone, quinaphthalone yellow, isoindoline yellow, tetrachloroisoindolinone, and quinophthalone yellow, and metallic flake materials such as aluminium flakes.

Examples of barrier pigments (sometimes referred to as anticorrosive pigments) include zinc dust and zinc alloys, and so-called lubricious pigments such as graphite, molybdenum disulfide, tungsten disulphide and boron nitride.

The pigment volume concentration of the coating composition preferably is in the range of 0 to 25 wt % based on the total weight of the coating composition. In embodiments, where pigments are included, they constitute 0.5 to 25 wt % of the coating composition, based on the total weight of the coating composition.

[Properties of the Coating Composition]

The coating composition in embodiments has a non-volatile content of 35 wt % or more, based on the entire weight of the coating composition. In further embodiments, the non-volatile content is 50 wt % or more, 70 wt % or more, 80 wt % or more, 90 wt % or more or 95 wt % or more. In embodiments, where no solvent or water is used, the non-volatile content can be 100 wt %. Non-volatile content can be determined according to ASTM D2697, e.g. D2697-03 (2014).

In embodiments, the touch dry time of the coating composition at 23° C. and 50% relative humidity is in the range of from 0.7 to 4 hours, for example in the range of from 1 to 3 hours. The touch dry time is the time at which slight pressure with a finger reveals no stickiness and leaves no mark in the coating.

In embodiments, the hard dry time is in the range of from 1 to 30 hours at 23° C. and 50% relative humidity, for example from 2 to 20 hours. The hard dry time is the time at which no film disruption and no marks occur when a thumb is pressed firmly on the surface and twisted through 180°.

In embodiments, the pot life of the coating composition is in the range of from 1 to 15 hours at 23° C. and 50% relative humidity, for example from 2 to 10 hours or from 3 to 8 hours.

The pot life can be determined using method ISO 9514.

[Preparation of the Coating Composition]

The coating composition may be prepared by any suitable technique.

In embodiments, the constituents are mechanically mixed, for example using a high-speed disperser, a ball mill, a pearl mill, a three-roll mill or an inline mixer.

The compositions may be filtered, for example using bag filters, patron filters, wire gap filters, wedge wire filters, metal edge filters, EGLM tumoclean filters (ex Cuno), DELTA strain filters (ex Cuno), and Jenag Strainer filters (ex Jenag), or by vibration filtration.

In embodiments, the composition is prepared and provided in the separate parts, where one part contains the terminally functionalised polysiloxane resin and the acrylate-based resin, and the other part separately comprises the cross-linking agent. Often these are provided in the form of a 2-pack (2K) system.

In an embodiment, the resin-containing part (part A) and the cross-linking agent-containing part component (part B) can be mixed and stirred until homogeneous. The mixture can then be applied to a substrate, optionally after a prior induction time.

[Application of the Coating Composition]

The coating composition can be applied to a substrate by known methods, for example by conventional air-spraying, by airless- or airmix-spraying equipment, or by 2K airless spray pumps. It can alternatively be applied using brush or roller, for example when used as a stripe coat. The composition can be applied at ambient conditions without pre-heating the coating composition. In spraying applications, conventional pressures such as 3 to 6 bara (bar-absolute) can be used.

The coating is typically applied so that a total dry film thickness of from 100-1000 μm is obtained, such as 100-500 μm or 150-350 μm. The applied film thickness can vary depending on the nature of substrate being coated and the environment to which it will be exposed.

[Coating Systems]

The coating composition can be used on its own or can be part of a coating system comprising more than one coating composition. It can be applied directly to a substrate surface or to a previously coated surface. For example, it can be applied on top of a primer, or an intermediate coat such as a tie-coat.

A particular benefit of the above-described coating compositions is the ability to combine the desirable attributes of good adhesion to undercoats or tie-coats, while still having highly effective fouling control properties.

In embodiments, the coating composition is applied directly to a primed surface. In further embodiments, the coating composition is applied to a tie-coat layer. The tie-coat can be on top of a primer layer, or directly on the substrate surface.

In embodiments, the coating composition is applied directly to a bare substrate. In other embodiments, the coating composition is applied to a previously coated substrate, such that it comprises one or more pre-existing and pre-cured and/or dried coating layers.

In embodiments, the coating composition is applied to a primer layer on the substrate.

In embodiments, the coating composition is applied to a tie-coat layer on the substrate, in which tie-coat layer is optionally on a primer layer on the substrate.

In embodiments, the coating composition forms part of a multi-coat system that additionally comprises a primer and/or a tie-coat.

The origin of the primer layer is not particularly limited, with typical examples including epoxy resin-based or polyurethane-based primer compositions.

Where a tie-coat layer is used, it is typically applied to a primer layer. In embodiments, the binder of the tie-coat composition comprises one or more silane moiety as defined above, e.g. of formula —Si(OR^{a})ₐ(R^{b})₃₋ₐ. The binder polymer of the tie-coat can, in embodiments, be selected from a polyurethane, polyurea, polyester, polyether, polyepoxy or poly(meth)acrylate binder. In further embodiments, the tie-coat binder is a poly(meth)acrylate binder. In embodiments, the poly(meth)acrylate binder is selected from those prepared by radical polymerisation or oligomerisation of monomer mixture comprising acrylate and/or (meth)acrylate monomers, at least one of which has a —Si(OR^{a})ₐ(R^{c})₃₋ₐ functional group. In embodiments, a is 3 and R^{a} is selected from methyl and ethyl. The monomer mixture can, in embodiments, comprise or consist of methyl methacrylate, lauryl methacrylate and trimethoxysilyl methyl methacrylate. In embodiments, the binder polymer of the tie-coat does not comprise functional groups other than a silane moiety.

[Substrate]

The substrate to which the coating can be applied can be one that is immersed, permanently or intermittently, in water. Substrates include metal, concrete, wood or polymeric surfaces.

Polymeric surfaces include polyvinyl chloride (PVC), or composites of fibre-reinforced resins. They also include flexible polymeric carrier foils, e.g. a PVC carrier foil to which the non-coated side is or can be adhered to a different surface.

In embodiments, the substrate is a submerged surface of a boat or ship, e.g. selected from one or more of the hull(s) (or at least the draft portion of the hull(s)), the propeller(s), the rudder(s) and the ballast tank(s).

### EXAMPLES

The invention will now be described with reference to the following, non-limiting examples.

[Materials]

The following components were used in the examples:

Functional Polysiloxanes:
(a) Dowsil™ 3074—methoxy functional methyl phenyl polysiloxane, with a weight average molecular weight, Mw, of 1200-1700.
(b) Silres™ IC 232—a methoxy functional methyl phenyl polysiloxane.

Silane-functionalised acrylate-based polymer:
(a) A trimethoxypropylsilane-functionalised acrylic terpolymer with a weight average molecular weight, Mw, of 2600, made from polymerisation of a monomer mixture 6.0 mol % trimethoxysilylpropyl methacrylate, 59.5 mol % methyl methacrylate and 34.5 mol % t-butyl acrylate.
(b) A trimethoxypropylsilane-functionalised acrylic terpolymer with a weight average molecular weight (Mw) of 4400 and a viscosity at 25° C. of 300 cP, prepared by polymerisation of a monomer mixture comprising 18.0 mol % trimethoxysilylpropyl methacylate, 70.0 mol % methyl methacrylate and 12 mol % lauryl methacrylate.
(c) A trimethoxypropylsilane-functionalised styrene/acrylic terpolymer prepared from a monomer mixture comprising 32.0 mol % butyl acrylate, 60.8 mol % styrene and 7.2 mol % trimethoxypropylsilane.

Non-curable polymeric fluid:
(a) Silube™ 812 from Siltech, based on lauryl PEG-8 dimethicone, with the following representative formula:

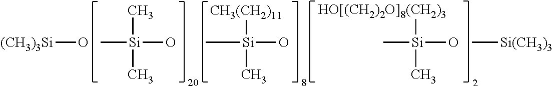

(b) E-10 perfluoropolyether

Other Curable Resins
(a) Laropal™ A81 urea-aldehyde resin
(b) Silikopon™ EF silicone epoxy resin

Cross-linking agents:
(a) Dynasylan™ AMEO (3-aminopropyl triethoxysilane)
(b) Silquest™ A-1100 (3-aminopropyl triethoxysilane)
(c) Dynasylan™ GLYMO (glycidoxypropyl trimethoxysilane)

Fillers and Pigments:
(a) Kronos™ 2064 titanium dioxide
(b) Bayferrox™ Red 140M
(c) Micafort™ SC3000 micronised Muscovite mica
(d) Blanc Fixe micro barium sulphate
(e) Portaryte™ B4 baryte
(f) Micafort™ SX300 micronised Muscovite mica
(g) Tiona™ 836 titanium dioxide
(h) Omya Hydrocarb™ 95T

Solvents:
(a) Xylene
(b) 1-methoxy-2-propyl acetate
(c) Petroleum naphtha aromatic 100
(d) Isopropyl alcohol

Others:
(a) Defoamer-BYK™-077 (polymethylalkylsiloxane)
(b) Thixotrope—Garamite™ 1958
(c) Thixotrope—Crayvallac™ PA4 X 20
(d) Defoamer—BYK™ 9076
(e) Dispersing agent—Disperbyk™ 111
(f) Thixotrope—Disparlon™ 6700
(g) Defoamer—BYK™ 085
(h) UV Stabiliser—Tinuvi™ 292
(i) K-Kat™ 670—Catalyst Various example and comparative coatings were formulated as follows.

### Comparative Example 1

Intershield™ 300—A commercially available anticorrosive primer from International Paints Ltd with no fouling control activity.

### Comparative Example 2

Intersleek™ 1100SR—A commercially available biocide-free foul-release coating from International Paints Ltd that comprises a fluorinated non-functional polymeric fluid.

### Comparative Examples 3 to 5

These compositions are set out in Table 1.

TABLE 1
Compositions of Comparative Examples 3-5 (values in weight %)

| | Comparative | | Comparative | | Comparative | |
|---|---|---|---|---|---|---|
| | Example 3 | | Example 4 | | Example 5 | |
| Functional Polysiloxane | (a) | 17.8 | (a) | 11.7 | (a)(b) | 18.9 |
| Silyl-Acrylic Polymer | (a): | 17.8 | (a)(b): | 37.7 | (c) | 9.5 |
| Other Curable Resin | (a) | 1.8 | (a) | 3.8 | (b) | 12.0 |
| Cross-Linking Agent | (a): | 5.0 | (b) | 1.9 | (a)(c) | 15.6 |
| Pigments and Fillers | (a)(c)(d): | 41.1 | (b)(c)(e): | 29.8 | (f)(g)(h) | 34.7 |
| Solvent | (a)(b)(c): | 11.9 | (a)(b)(c): | 11.0 | (c)(d) | 5.6 |
| Others | (a)(b)(c)(d): | 4.6 | (a)(b)(d): | 4.1 | (e)(f)(g)(h)(i) | 3.7 |

### Examples 1 to 5

These are based on Comparative Coatings 3, 4 and 5, but comprise additional fluids as set out below:
Example 1—Comparative Example 3+10 wt % of Silube™ 812.
Example 2—Comparative Example 4+10 wt % Silube™ 812.
Example 3—Comparative Example 5+10 wt % Silube™ 812.
Example 4—Comparative Example 5+3.5 wt % Silube™ 812 Example 5—Comparative Example 5+5.0 wt % Fluorolink™ E10/6

### Comparative Example 6

This is based on Comparative Coating 5, but additionally comprising 2.9 wt % petrolatum.

### Experiment 1—Fouling Testing

6 or 12 coatings were applied to 60 cm×60 cm wooden boards in a “latin square” lay-out. They were then fully immersed on a raft at the coastal locations specified below. Photographs of boards were taken at regular intervals. From the photographs, the fouled area of each square was then assessed, based on a rating of 1 to 100, where 1 is low and 100 is high. Tables 2 and 3 show the results of average fouling coverage at different locations over the specified time-periods in weeks.

TABLE 2
Fouling Results for UK Locations

| Location | Ardfern | Weymouth | | | |
|---|---|---|---|---|---|
| Immersion Time (weeks) | 52 | 7 | 12 | 12 | 57 |
| Coating | Fouling Rating | | | | |
| Comparative Example 1 | 35.0 | | | 23.6 | 62.1 |
| Comparative Example 2 | 14.0 | 6.3 | | 3.8 | 22.0 |
| Comparative Example 3 | | | 20.4 | 23.3 | |
| Comparative Example 5 | | | 21.1 | | |
| Example 1 | 8.0 | | 9.3 | 6.5 | 16.6 |
| Example 2 | | 3.4 | | | |
| Example 3 | | | 12.9 | | |

TABLE 3
Fouling Results for Other Locations

| | Bratton | Geoje | Changi | | | |
|---|---|---|---|---|---|---|
| Location | (Sweden) | (S. Korea) | (Singapore) | | | |
| Immersion Time | 20 | 30 | 4 | 9 | 18 | 26 |
| (wks) | | | | | | |
| Coating | Fouling Rating | | | | | |
| Comp. Example 1 | 20.2 | 31.4 | | 75.0 | 100.0 | 71.1 |
| Comp. Example 2 | 14.3 | 11.9 | | | 31.6 | 28.8 |
| Comp. Example 3 | | | 13.5 | | | |
| Comp. Example 5 | | | 12.6 | | | |
| Example 1 | 16.7 | 15.7 | 8.1 | | 33.6 | 58.7 |
| Example 2 | | | | 60.0 | | |
| Example 3 | | | 3.0 | | | |

These results show the antifouling activity of the inventive samples is either comparable to or even better than a high-performance benchmark composition (Intersleek™ 1100SR, comparative example 2).

### Experiment 2—Fouling Testing

Coatings of Examples 4, 5 and Comparative Example 6 were immersed for 5 weeks in Changi, Singapore, following the same protocol as Experiment 1. The results are shown in Table 4.

TABLE 4
Fouling Results Comparing Different Fluids (Changi, 5 weeks)

| Coating | Fouling Rating |
|---|---|
| Example 4 | 7.5 |
| Example 5 | 5.5 |
| Comparative Example 6 | 46.1 |

These results show a clear improvement in fouling control performance when using a polymeric or oligomeric fluid according to the invention, compared to a non-polymeric/oligomeric fluid based on a crude oil-derived hydrocarbon mixture.

### Experiment 3—Overspray Simulation

This experiment was intended to show the effects of the comparative and example coating compositions on subsequently applied coating layers. The experiment mimics a situation where an overspray occurs, i.e. a small amount of paint on a non-target area, which can affect subsequently applied coatings.

The example or comparative coating composition (5 g) was mixed together and dissolved in xylene (95 g). This solution was applied using a 50 μm draw-down bar to a glass test panel and allowed to dry and cure under ambient conditions for 24 hours. A polyurethane-based cosmetic coating was then applied onto the pre-coated glass panel to give a wet coating thickness of 150 μm. It was then left to dry under ambient conditions for 24 hours.

The amount of surface defect of the top cosmetic coating was then assessed visually, and a score applied as follows, with results shown in Table 5:
1—Top coating unaffected
2—Defects visible over 1-20% of the top-coat surface
3—Defects visible over 21-50% of the top-coat surface
4—Defects visible over greater than 50% of the top-coat surface

TABLE 5
Defect Assessment for Subsequently Applied Top-Coat

| Coating | Defect Score |
|---|---|
| Comparative Example 2 | 4 |
| Example 1 | 0 |
| Example 2 | 0 |
| Example 3 | 0 |

These results clearly demonstrate that the inventive coatings cause substantially less defects in subsequently applied coatings, meaning that the consequences of overspray or unintended contamination of parts of a surface are less damaging than a comparative fouling release coating. This is also achieved without detriment to the intended foul release properties.

### Experiment 4—Coating Hardness

The coatings were tested for their hardness after drying and curing. Increased harness is associated indicative of better in-service abrasion and damage resistance.

Each coating was applied to 2 glass panels to give a wet film thickness of 225 μm, before being allowed to dry and cure for 3 days at ambient conditions. They were then assessed for hardness using Fischer Microhardness apparatus, according to ISO14577. The test involved using a programmed sequence to take 9 readings across each panel, by applying pressure to the hardness probe perpendicular to the panel surface in order to create an indentation.

The distance of probe penetration and the forces involved were recorded and used to generate the data shown in Table 6.

TABLE 6
Coating Hardness Results

| | Mean | Average | Average |
|---|---|---|---|
| | Harness | Indentation | Elasticity |
| Coating | (N mm⁻²) | Modulus (MPa) | (%) |
| Comparative Example 2 | 0.22 | 3.09 | 100.62 |
| Example 1 | 18.29 | 639.85 | 20.67 |
| Example 2 | 20.76 | 587.85 | 24.97 |
| Example 3 | 34.27 | 693.66 | 40.10 |

These results demonstrate that, compared to a commercially available fouling release reference coating, the inventive coatings have harder, less elastic properties, indicating improved abrasion and damage resistance. This is achievable with improved, or at least comparable, fouling release performance.

### Experiment 5—Adhesion Properties

This experiment was intended to examine longevity of adhesion of the coatings when exposed to water or sea water for extended periods of time.

Coating layers were applied to a substrate as set out in Table 5, based on an epoxy primer, a tie coat and a top coat, where the top coat is a comparative or example coating as set out above. The primers and tie-coats used were commercially available grades. 24 hours after the last coating was applied, the test pieces were then immersed in sea water or fresh water for a period of 3 months. They were then tested for coating adhesion.

This test involved cutting a cross shape through all the coating layers, and then rubbing the cut area with a gloved finger to assess how easily the coating layers separated. The coating temperature at the time of the test was 23° C. Results are shown in Table 7, and adhesion ratings are based on scores between 0 and 5, where 5 is the highest performance score (greatest adhesion), and 0 the lowest (very poor adhesion). A score of 3-5 is considered to be a “pass”, whereas 0-2 is considered a “fail”.

The results demonstrate that the inventive coating compositions can adhere directly and efficiently to commonly used primers, without the need for a tie-coat. Compared to the fouling release reference material (comparative example 2), this means that an easier application scheme can be used, requiring fewer coating layers.

TABLE 7
Adhesion Results

| | | | Adhesion |
|---|---|---|---|
| Primer | Tie-Coat | Top Coat | Rating |
| Intershield ™ 300 | None | Comp. Example 2 | 0 |
| Intershield ™ 300 | Intersleek ™ 737 | Comp. Example 2 | 5 |
| Intershield ™ 300 | Intersleek ™ 731 | Comp. Example 2 | 5 |
| Primocon ™ | None | Example 2 | 5 |
| Intergard ™ 263 | None | Example 1 | 5 |
| Interplus ™ 356 | None | Example 1 | 5 |
| Intergard ™ 263 | None | Example 3 | 5 |
| Intershield ™ 300 | None | Example 3 | 5 |
| Interplus ™ 356 | None | Example 3 | 5 |

1. A fouling control coating composition comprising:
(i) a functional polysiloxane,
(ii) a functionalised acrylate-based polymer, and
(iii) a non-curable polymeric or oligomeric fluid that is liquid at 25° C. and atmospheric pressure, where the functional polysiloxane and the functionalised acrylate-based polymer each comprise a silane moiety of formula —Si(R^{b})₃₋ₐ(OR^{a})ₐ, in which
each R^{a} is independently selected from H, and C₁₋₁₂ alkyl, phenyl, and phenyl with one or more C₁₋₆ alkyl substituents, each R^{a} group optionally comprising one or more substituents selected from halide, OR^{t} and NR^{t}₂
each R^{b} is independently selected from H and R^{c},
each R^{c} is independently selected from C₁₋₂₀ aliphatic hydrocarbyl groups, C₆₋₁₂ aryl groups, and C₆₋₁₂ aryl groups having one or more C₁₋₆ alkyl groups, each R^{c} optionally comprising one or more substituents selected from from halide, —OR^{t}, —NR^{t}₂, —NCO, —C(O)R^{t}, —C(O)OR^{t}, —OC(O)R^{t}, —C(O)NR^{t}₂, —OC(O)NR^{t}₂, —NR^{t}C(O)NR^{t}₂, —OC(O)OR^{t}, —([CR^{t}₂]ⱼE-)ₚR^{t}, -E-([CR^{t}₂]ⱼE-)ₚR^{t} and —(CR^{t}₂)ⱼ[O(CR^{t}₂)ₖ]ₘ[CR^{t}(O)CR^{t}₂], where [CR^{t}(O)CR^{t}₂]represents an epoxy moiety;
each R^{t} is independently selected from H, C₁₋₆ alkyl and C₁₋₆ haloalkyl;
each E is independently selected from —O— and —NR^{t};
a is an integer in the range of from 1 to 3;
j is in the range of from 1 to 6;
k is in the range of from 2 to 3;
m is in the range of from 0 to 3; and
p is in the range of from 1 to 20.

2. The fouling control coating composition as claimed in claim 1, in which the functionalised acrylate-based polymer comprises one or more acrylate-based monomer units derived from monomers represented by the Formula (4): 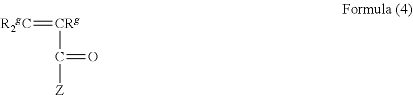
where:
Z is selected from —OR^{h} and —NR^{h}₂;
each R⁹ is selected from H, C₁₋₂₀ aliphatic hydrocarbyl, C₆₋₁₂ aryl, C₆₋₁₂ aryl with one or more C₁₋₆ aliphatic hydrocarbyl substituents; and
each R^{h} is independently selected from H and C₁₋₂₀ alkyl; wherein each R^{h} and R^{g} optionally comprise one or more substituents selected from halide, —OR^{t}, —NR^{t}₂, —NCO, —C(O)R^{t}, —C(O)OR^{t}, —OC(O)R^{t}, —C(O)NR^{t}₂, —OC(O)NR^{t}₂, —NR^{t}C(O)NR^{t}₂, —OC(O)OR^{t}, —([CR^{t}₂]ⱼE-)ₚR^{t}, -E-([CR^{t}₂]ⱼE-)ₚR^{t} and —(CR^{t}₂)ⱼ[O(CR^{t}₂)ₖ]ₘ[CR^{t}(O)CR^{t}₂].

3. The fouling control composition as claimed in claim 2, in which the functionalised acrylate-based polymer comprises one or more monomer units derived from monomers of Formula (4), in which Z is selected from OR^{h}, and R^{h} is selected from C₁₋₁₂ alkyl substituted with the silane moiety of formula —Si(R^{b})₃₋ₐ(OR^{a})ₐ.

4. The fouling control coating composition as claimed in claim 1, in which the functionalised acrylate-based polymer comprises one or more styrene comonomers of formula R^{j}₂C═CR^{k}R^{j}, where each R^{j} is selected from H, halide and C₁₋₆ alkyl, and R^{k} is selected from phenyl, phenyl with one or more C₁₋₆ alkyl groups, where each R^{j} and R^{k} is optionally substituted with halide, OR^{t} and NR^{t}₂.

5. The fouling control coating composition as claimed in claim 1, in which acrylate-based monomer units make up 10% or more of the functionalised acrylate-based polymer on a molar basis.

6. The fouling control composition as claimed in claim 1, in which the functional polysiloxane is represented by the formula: 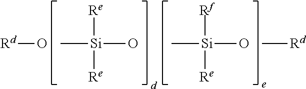
where;
each R^{d} is independently selected from H and R^{e};
each R^{c} is independently selected from C₁₋₆ alkyl, phenyl and phenyl with one or more C₁₋₆ substituents;
each R^{f} is independently selected from C₆₋₁₀ aryl, C₆₋₂₀ aliphatic hydrocarbyl and C₆₋₁₀ aryl having one or more C₁₋₆ aliphatic hydrocarbyl substituents;
where each R^{d}, R^{e} and R^{f} optionally comprise one or more substituents selected from halide, —OR^{t}, —NR^{t}₂, —NCO, —C(O)R^{t}, —C(O)OR^{t}, —OC(O)R^{t}, —C(O)NR^{t}₂, —OC(O)NR^{t}₂, —NR^{t}C(O)NR^{t}₂, —OC(O)OR^{t}, —([CR^{t}₂]ⱼE-)ₚR^{t}, -E-([CR^{t}₂]ⱼE-)ₚR^{t} and —(CR^{t}₂)ⱼ[O(CR^{t}₂)ₖ]ₘ[CR^{t}(O)CR^{t}₂];
R^{f} is different from all R^{d} and R^{e} groups;
d is in the range of from 1 to 100;
e is in the range of from 0 to 99; and
the sum of d+e is in the range of from 5 to 100.

7. The fouling control composition as claimed in claim 6, in which all R^{d} and R^{e} are C₁₋₆ alkyl, and R^{f} is phenyl or C₁₋₆ alkyl-substituted phenyl.

8. The fouling control composition as claimed in claim 1, in which the non-curable oligomeric or polymeric fluid is selected from non-functional polysiloxanes, non-functional polyethers, non-functional perfluoropolyethers and non-functional halogenated hydrocarbon polymers.

9. The fouling control composition as claimed in claim 8, in which the non-curable oligomeric or polymeric fluid is a non-functional polysiloxane selected from those of formula: 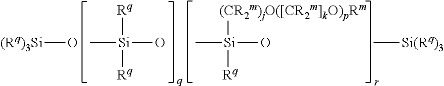
where
each R^{m} is independently selected from H, C₁₋₄ alkyl and C₁₋₄ haloalkyl
each R^{q} is independently selected from C₁₋₂₀ alkyl, phenyl and phenyl having one or more C₁₋₆ alkyl substituents, each R^{q} optionally comprising one or more substituents selected from —OR^{t}, —NR^{t}₂, —C(O)R^{t}, —([CR^{t}₂]ⱼE-)ₚR^{t}, -E-([CR^{t}₂]ⱼE-)ₚR; and
q and r are relative molar ratios of the individual siloxane units in the non-functional polysiloxane,
where the ratio of q:r is selected from the following ranges: from 0.1:1 to 100:1, from 1:1 to 70:1, and from 2:1 to 35:1.

10. A fouling control coating composition as claimed in claim 1, in which one or more of the following apply:
(i) the functional polysiloxane, non-curable polymeric or oligomeric fluid and the functionalised acrylate-based polymer comprise no halide substituents and no halide-containing substituents;
(ii) the functionalised acrylate-based polymer comprises one or more styrene comonomers, where each R^{j} is selected from H and methyl, and R^{k} is phenyl or C₁₋₄ alkyl-substituted phenyl;
(iii) at least one silane moiety on the functionalised acrylate-based polymer is on group Z of an acrylate-based monomer unit of Formula (4): 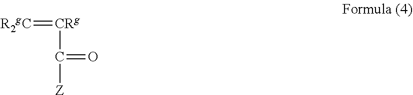
where:
Z is selected from —OR^{h} and —NR^{h}₂;
each R⁹ is selected from H, C₁₋₂₀ aliphatic hydrocarbyl, C₆₋₁₂ aryl, C₆₋₁₂ aryl with one or more C₁₋₆ aliphatic hydrocarbyl substituents; and
each R^{h} is independently selected from H and C₁₋₂₀ alkyl; wherein each R^{h} and R⁹ optionally comprise one or more substituents selected from halide, —OR^{t}, —NR^{t}₂, —NCO, —C(O)R^{t}, —C(O)OR^{t}, —OC(O)R^{t}, —C(O)NR^{t}₂, —OC(O)NR^{t}₂, —NR^{t}C(O)NR^{t}₂, —OC(O)OR^{t}, —([CR^{t}₂]ⱼE-)ₚR^{t}, -E-([CR^{t}₂]ⱼE-)ₚR^{t} and —(CR^{t}₂)ⱼ[O(CR^{t}₂)ₖ]ₘ[CR^{t}(O)CR^{t}₂];
(iv) at least one silane moiety on the functional polysiloxane is at a terminal position;
(v) the functionalised acrylate-based polymer comprises at least 20 mol % monomer units derived from acrylate-based monomers;
(vi) the coating composition further comprises one or more cross-linking agents at a concentration of 0.1 to 30 wt %;
(vii) the coating composition comprises one or more additional curable resins at a concentration of 20 wt % or less;
(viii) the coating composition has a solids content of 50 wt % or more, or 70 wt % or more;
(ix) the coating composition comprises no more than 15 wt % marine biocide;
(x) the coating composition comprises no more than 5 wt % water;
(xi) the total content of functional polysiloxane in the coating composition is in the range of from 3 to 50 wt %;
(xii) the total content of functionalised acrylate-based polymer(s) in the coating composition is in the range of from 5 to 70 wt %;
(xiii) the total content of non-curable oligomeric or polymeric fluid(s) in the coating composition is in the range of from 2 to 40 wt %.

11. A method for controlling aquatic biofouling on a man-made object, comprising applying to the surface of a man-made structure a fouling control coating composition as claimed in claim 1.

12. The method as claimed in claim 11, in which the fouling control coating composition has dried and/or cured.

13. A substrate or article comprising a coating of the fouling control coating composition as claimed in claim 1.

14. The substrate or article of claim 13, in which the fouling control coating composition has been dried and/or cured.

15. The use of a fouling control coating composition as claimed in claim 1 for controlling aquatic biofouling of a man-made structure.
